(19) United States
(12) Patent Application Publication
(10) Pub. No.: US 2015/0082966 A1
(43) Pub. Date: Mar. 26, 2015

(54) Compani Fingerboards for Stringed Musical Instruments

(71) Applicant: Behrooz Compani-Tabrizi, Laguna Hills, CA (US)

(72) Inventor: Behrooz Compani-Tabrizi, Laguna Hills, CA (US)

(21) Appl. No.: 14/306,311

(22) Filed: Jun. 17, 2014

Related U.S. Application Data
(60) Provisional application No. 61/880,271, filed on Sep. 20, 2013.

(51) Int. Cl. G10D 3/06

(52) U.S. Cl. CPC G10D 3/06
USPC 84/314 R

(57) ABSTRACT

Conventional stringed musical instrument fingerboards are constructed with a constant longitudinal slope, relative to the string, along the fingerboard's length direction. Fingerboards with variations in their slope along their length direction could improve playability by shortening the string-to-fingerboard distances. A variable slope fingerboard is suggested to improve playability at locations close to the bridge.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention is related to the shaping of the fingerboards of stringed musical instruments, such as, but not limited to guitars, violins, cellos, basses, banjoes, mandolins, tars, ouds and lutes.

2. Description of the Related Art

The fingerboard is the neck or usually a strip made of material (e.g., wood) glued on the neck of a stringed musical instrument against which the strings are pressed to produce different musical notes. Fingerboards are also called fretboards in fretted instruments.

The present stringed musical instrument fingerboards are constructed with a single constant slope that may be adjustable but does not vary along the length of the fingerboard. The present fingerboard constructions make the string-to-fingerboard distances for many of the higher pitched notes unnecessarily larger than required causing hardship in playability. Mitigation of this hardship is the accomplishment of this invention.

### BRIEF SUMMARY OF THE PRESENT INVENTION AND JUSTIFICATIONS

The maximum amplitude of vibrations of a string with fixed end points occurs in the middle of the string and corresponds to the principle frequency (e.g., the longest wavelength). In a stringed musical instrument, the global maximum amplitude of vibrations, for all possible playable notes on a string, occurs at the middle of the open strings. In conventional instruments this maximum amplitude dictates and sets the minimum constant angle of the fingerboard with the stretched strings. This minimum and constant angle is selected by the luthier to simultaneously maximize ease of playability but avoid or minimize buzzing sounds.

Pressing the string against the fingerboard at higher positions shortens the string vibrating length and produces higher pitched notes. For the higher and higher notes the maximum amplitude of vibrations become smaller and smaller and the angle between the pressed string and the fingerboard becomes larger.

Finally, immediately after a string is struck it settles into standing wave vibrational modes that are symmetric with respect to the middle of the string. This suggests that the angle of the fingerboard with the string could also be made symmetric about the same point.

These facts suggest that past the middle of the string position one can construct fingerboards with continuous or abrupt slope changes (i.e. upward bends towards the string) in the longitudinal direction, so as to shorten the string-to-fingerboard distances and still avoid buzzing.

This invention relates to fingerboards with varying longitudinal slopes, here refereed to as Compani fingerboards.

### BRIEF DESCRIPTION OF THE DRAWINGS

Number of longitudinally varying slope fingerboard designs is not finite due to the continuous nature of slope angles. Therefore examples designs are provided in the FIGS. 2-4 without numerically specifying the slopes.

FIG. 1 shows the side view and the perspective view of a conventional fingerboard with a constant longitudinal slope relative to the string.

FIG. 2 shows the side view of a two-slope fingerboard where a portion of the fingerboard runs parallel to the string. Continuation of the left part of the fingerboard is shown by a narrow line to show the closer proximity of the fingerboard to the string in the new design at higher note positions.

FIG. 3 shows the side view of a fingerboard with exaggerated longitudinally and continuously varying slope.

FIG. 4 shows the perspective view of a two-slope fingerboard with lateral convexity (called radius or compound radius fingerboards) where a portion of the fingerboard is angled up towards the string. Continuation of the left part of the fingerboard is shown by narrow lines to indicate the closer proximity of the new design to the string at higher note positions.

### DETAILED DESCRIPTION OF THE INVENTION

With the justifications given in the summary, I propose a longitudinally varying slope fingerboard construction. The longitudinal variations in slope can be made as continuous longitudinal variations, as a discrete jump in slope at a single point, as discrete changes in slope at several points, or as a combination of partly continuous and partly discrete jump(s) in slope along the fingerboard direction to improve playability. In particular a relatively easy construction is one that keeps a constant fingerboard slope from the nut to around the middle of the string and changes its slope upward by a constant amount towards the string for all other positions. The slope changes are made by degree amounts to simultaneously avoid or minimize buzzing and to accommodate the particular needs of players and the stringed musical instruments. These fingerboard constructions are applicable to all musical instruments with flat or the laterally varying slope (“radius” or “arched”) fingerboards. There are three advantages attributed to the longitudinally varying slope fingerboards.

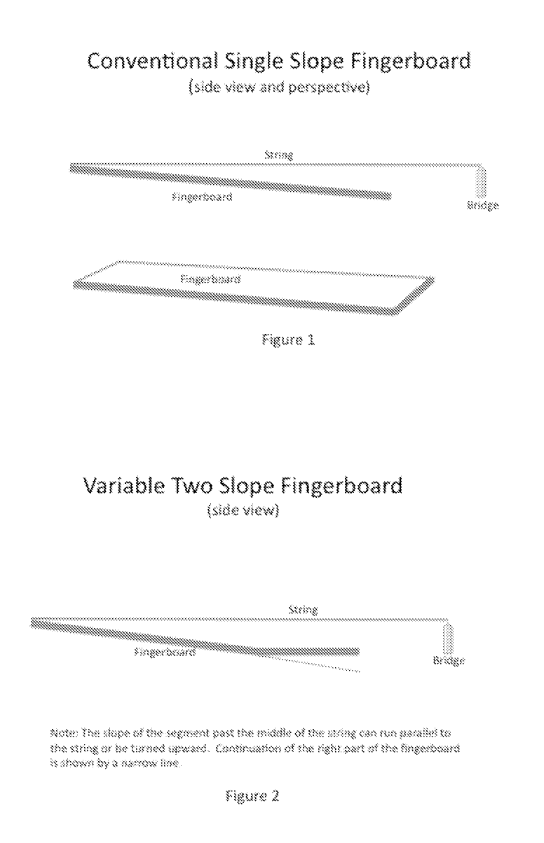

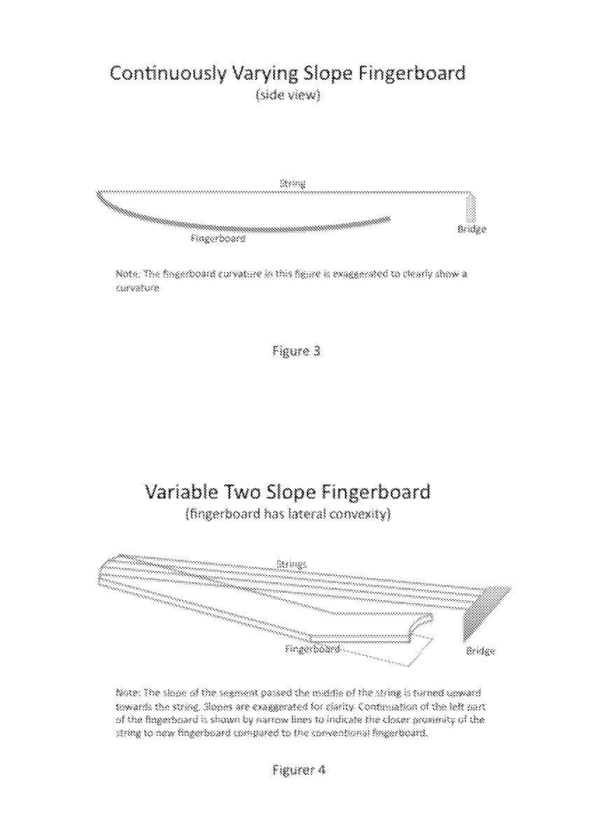

1. The contoured slopes improve functionality and playability, by generally shortening distances between the string and the fingerboard. Examples are illustrated in FIGS. 2-4. In these constructions, the closer distances of the strings to the fingerboard require less physical pressure and improve playability comfort.

2. The closer distances of the strings to the fingerboard require less string-to-fingerboard contact time, as the string is pressed through a shorter distance, and improve speed of playability.

3. The closer distances of the strings to the fingerboard results in smaller string tension build up due to string stretching when the strings are pressed against the fingerboard. Therefore, the increase in the frequency of the played notes is smaller compared to the increase in the constant slope fingerboards. Fret position compensations for fretted fingerboards and player compensations, at playing time, to eliminate these frequency increases are smaller, and easier to make, than in the constant longitudinal slope fingerboard constructions.

1. Fingerboards with variable longitudinal slope, that is the slope relative to the string along the string direction, of stringed musical instruments with a single constant longitudinal slope from the nut to about the midpoint between the nut and the saddle with changes in slope passed this point in any manner which results in shorter string to fingerboard distances compared to their corresponding single constant slope alternatives.

2. Fingerboards with variable longitudinal slope, that is the slope relative to the string along the string direction, of stringed musical instruments with a single constant longitudinal slope from the nut to a point past the midpoint between the nut and the saddle with changes in slope passed this point in any manner which results in shorter string to fingerboard distances compared to their corresponding single constant slope alternatives.
